(19) United States
(12) Patent Application Publication
(10) Pub. No.: US 2012/0283025 A1
(43) Pub. Date: Nov. 8, 2012

(54) METHOD OF DECOMMISSIONING CARDS

(75) Inventors: Attila Grauzer, Las Vegas, NV (US); Oliver M. Schubert, Las Vegas, NV (US); James V. Kelly, Las Vegas, NV (US); James B. Stasson, Eden Prairie, MN (US); Ronald R. Swanson, Otsego, MN (US); Troy D. Nelson, Big Lake, MN (US); Michael Bacigalupi, Henderson, NV (US)

(73) Assignee: Shuffle Master, Inc., Las Vegas, NV (US)

(21) Appl. No.: 13/542,512

(22) Filed: Jul. 5, 2012

Related U.S. Application Data
(63) Continuation of application No. 12/717,021, filed on Mar. 3, 2010, now abandoned.
Application No. 12/717,021 is a continuation of application No. 11/881,432, filed on Jul. 27, 2007, now abandoned.
Application No. 11/881,432 is a continuation of application No. 10/954,152, filed on Sep. 28, 2004, now abandoned.
Application No. 10/954,152 is a continuation-in-part of application No. 10/880,410, filed on Jun. 28, 2004, now abandoned.
Application No. 10/880,410 is a continuation-in-part of application No. 10/880,408, filed on Jun. 28, 2004, now abandoned.
Application No. 10/880,408 is a continuation-in-part of application No. 10/622,388, filed on Jul. 17, 2003, now Pat. No. 7,278,923.

(51) Int. Cl. G06F 17/00

(52) U.S. Cl. 463/43

(57) ABSTRACT

A card verification station moves and reads suit and rank of individual cards. The cards are provided to a card in-feed area and moved individually to a card collection area. A device may comprise: a) a card in-feed area with card-moving elements that move only a bottom card from a set of cards in the card in-feed area; b) a card collection area that receives cards from the card in-feed area in the same order as cards are received in the card in-feed area; c) an image capture device that captures data from a card while the card is between the card in-feed area and the card collection area; d) a processor capable of controlling the operation of the card verification station; and e) an elevator that lowers to maintain a level at which cards are received in the card collection area. A method of verifying a group of playing cards is also disclosed.

### CROSS-REFERENCE TO RELATED APPLICATIONS

This application is a continuation of U.S. patent application Ser. No. 12/717,021, filed Mar. 3, 2010, pending, which application is a continuation of U.S. patent application Ser. No. 11/881,432, filed Jul. 27, 2007, now abandoned, which is a continuation of U.S. patent application Ser. No. 10/954,152, filed Sep. 28, 2004, now abandoned, which is also a continuation-in part of U.S. patent application Ser. Nos. 10/880,410, filed Jun. 28, 2004, now abandoned, and a continuation-in-part of U.S. patent application Ser. No. 10/880,408, filed Jul. 28, 2004, now abandoned, and also a continuation-in-part of U.S. patent application Ser. No. 10/622,388 filed Jul. 17, 2003, now U.S. Pat. No. 7,278,923, issued Oct. 9, 2007, the disclosure of each of which is hereby incorporated herein by this reference in its entirety.

### TECHNICAL FIELD

The present invention relates to components, systems, methods and apparatus for the identification, reading, verification and/or tracking of playing cards, card hands and sets of playing cards in a gaming environment, such as in casino table card games.

### BACKGROUND

Casinos and other forms of gaming constitute a very large industry. Large amounts of money are exchanged and placed at risk and it has always been a significant concern of the industry to protect the casinos and players against fraudulent events. In casino table card games, there are generally three areas of risk in fraud: 1) falsifying/replacing playing cards, 2) falsifying/replacing chips, and 3) passing of information improperly. Casinos would also classify certain forms of play at card games as at least undesirable, if not excludable (such as card counting).

Numerous different methods have been proposed and instituted to defend against these types of fraud. There is extensive physical surveillance of casinos, both directly by personnel and less intrusively by overhead cameras that view and record wagering and play activities. Trained personnel watch the play of games and individual players, identifying situations and events that indicate problems. Although most of these trained individuals can detect chip substitution, card exchanges and some forms of unauthorized player/dealer communications, it is difficult for the observers' attention to be consistently maintained at the highest levels.

There are other reasons for observing the play of casino table card games, such as to rate the efficiency of dealers over time, to rate the efficiency of players over time, and to provide a statistical basis for analysis of new games. This type of collected data can assist the casino in rating players for comps and special invitations, and in identifying preferred dealers for higher-stake tables.

While some aspects of a casino's security system should be plainly visible as a deterrent, other aspects of the security should be unobtrusive to avoid detracting from the players' enjoyment of the game and to prevent cheaters and thieves from avoiding detection. Some of the current methods of tracking have drawbacks. The methods typically depend on manual observation of a gaming table. Thus, coverage is not comprehensive, and is limited to tracking a relatively small number of games, customers and employees. This problem is exacerbated by a customer's ability to rapidly move between gaming tables. A commonly known method for cheating customers to avoid detection is to switch tables frequently. The tracking methods are also prone to error, since the manual methods rely on human observers who can become inattentive or distracted. In one commonly known method of cheating the casino, one member of a team will create a distraction while another member steals chips or swaps cards. These manual tracking methods are also labor-intensive, and thus costly.

The advance of technology in the fields of imaging, symbol recognition, computers and software has enabled the potential for greater utilization of technology to automatically provide a basis for security as opposed to merely providing a source of information for humans to evaluate. Security-enhancing systems are needed in various different aspects of the play of casino table card games, and many different systems have been proposed.

U.S. Pat. No. 6,126,166 to Lorson et al. describes an integrated blackjack game control system having multiple sensors and output devices, electronic signal processing equipment, passive and active operator control devices, and a computer system. The system components are capable of being installed on or near existing blackjack tables and support equipment, and to operate with standard playing cards. The system performs several simultaneous functions to accelerate the play of a game of blackjack, enhance the shuffling process, and perform continuous monitoring of key dealer and table performance attributes. The system gathers information on the distribution of cards in the discard shoe from knowledge of the sequence of cards dealt during game play. When signaled, the system determines appropriate sequence, number, and positions of the pre-shuffle plug locations of the cards in the discard shoe. The system transmits the pre-shuffle card plug information to an output device driver assembly that actuates the desired output devices. In one implementation, the system output devices are light-emitting diodes, but any number of electric, acoustic, or mechanical devices could be utilized.

U.S. Pat. No. 6,299,536 to Hill describes a playing card-dispensing shoe apparatus, system and method, wherein the shoe has a card scanner that scans the indicia on a playing card as the card moves along and out of a chute of the shoe by operation of the dealer. The scanner is located on the outlet end of the dispenser, not within any card-moving element internal to the device. The scanner comprises an optical sensor used in combination with a neural network that is trained using error back-propagation to recognize the card suits and card values of the playing cards as they are moved past the scanner, so specially coded information is not needed. The scanning process, in combination with a central processing unit (CPU), determines the progress of the play of the game and, by identifying card-counting systems or basic playing strategies in use by the players of the game, provides means to limit or prevent casino losses and calculate the theoretical win of the casino, thus also providing an accurate method of determining the amount of comps to be given a particular player. The shoe is also provided with additional devices that make it simple and easy to access, record and display other data relevant to the play of the game. These include means for accommodating a “customer-tracking card” that reads each player's account information from a magnetic stripe on the card, thus providing access to the player's customer data file stored on the casino's computer system, and one or more alphanumeric keyboards and LCD displays used to enter and retrieve player and game information. Also included are keyboards on the game table so that each player can individually select various playing or wagering options using their own keyboard. The system is more focused on analysis of overall play at a table and by individuals, rather than identifying specific hands and play at each round of a card game. The system evaluates individual player strategy and proficiency after the read card information is sent to a computer.

U.S. Pat. No. 4,667,959 to Pfeiffer et al. describes a card-shuffling apparatus having a card hopper adapted to hold from one to at least 104 cards, a card carousel having slots for holding cards, an injector for sequentially loading cards from the hopper into the carousel, output ports, ejectors for delivering cards from the carousel to any one of the output ports, and a control board and sensors, all housed in a housing. The apparatus is capable of communicating with selectors that are adjustable for making card selections. The injector has three rollers driven by a motor via a worm gear. A spring-loaded lever keeps cards in the hopper pressed against the first roller. The ejectors are pivotally mounted to the base of the housing beneath the carousel and comprise a roller driven by a motor via gears and a centripetal clutch. A control board keeps track of the identity of cards in each slot, card selections, and the carousel position. Cards may be ordinary playing cards or other cards with bar codes added for card identification by the apparatus.

U.S. Pat. No. 4,750,743 to Nicoletti describes a card-dispensing device that requires the use of a mechanical means to advance cards out of the shoe. Specifically described is a dispenser for playing cards, comprising: a shoe adapted to contain a plurality of stacked playing cards, the playing cards including a leading card and a trailing card; the shoe including a back wall, first and second side walls, a front wall, a base, and an inclined floor extending from the back wall to proximate the front wall and adapted to support the playing cards; the floor being inclined downwardly from the back wall to the front wall; the front wall having an opening and otherwise being adapted to conceal the leading card; the front wall, side walls, base and floor enclosing a slot positioned adjacent the floor, the slot being sized to permit a playing card to pass through the slot; card advance means contacting the trailing card and adapted to urge the stacked cards down the inclined floor; card-dispensing means positioned proximate the front wall and adapted to dispense a single card at a time, the card-dispensing means including leading card contact means adapted for rotation about an axis parallel to the leading card, whereby rotation of the leading card contact means displaces the leading card relative to the card stack and into a predetermined position extending out of the shoe from the slot; and an endless belt located in the opening in the front wall for rotating the leading card contact means, the endless belt having an exterior surface securely engaging the leading card contact means and being adapted to be displaced by an operator.

U.S. Pat. No. 5,681,039 to Miller describes a “no peek” card-reading device for speeding up the pace of a game of blackjack. The device is comprised of a housing having a top surface. A card reader for reading at least a portion of a playing card is located within the housing. An indicator cooperating with the card reader is provided to inform the dealer if his down card is of a desired value. There is also disclosed therein a method for increasing the speed of play in an organized game of blackjack. The system includes a device for reading alphanumeric indicia on cards of a deck of playing cards in a game of blackjack to indicate to a dealer whether or not the dealer has been dealt “21,” comprising: (a) a housing having a means for receiving at least a portion of a playing card when such card is disposed face down on a blackjack table; (b) means for directly reading at least a portion of the alphanumeric indicia on said card while the card is disposed adjacent said means for receiving; and (c) means for indicating, based on the portion of the alphanumeric indicia read, when the dealer has been dealt “21,” said indicating means being connected to said means for reading.

U.S. Pat. No. 5,989,122 to Roblejo describes a card-shuffling apparatus for randomizing and verifying sets of playing cards. Also, the invention relates to a process for providing such an apparatus; feeding to the apparatus one or more cards, either after they have been played in a game or from an unrandomized or unverified set of cards; and manually retrieving a verified true set of cards from the apparatus. Also, the invention relates to a process of playing, in a casino setting or simulated casino setting, a card game comprising the steps of: providing such an apparatus, feeding unverified sets of playing cards to the apparatus, and recovering verified true sets of cards from the apparatus.

U.S. Pat. Nos. 5,605,334; 6,093,103 and 6,117,012 to McCrea Jr. describe a secure game table system, adapted for multiple sites under a central control, for monitoring each hand in a live card game. A common deck identity code is located on each card. A shuffler has a circuit for counting the cards from a previous hand, which are inserted into the shuffler, which, in turn, reads the common identity code. The game control verifies that no cards have been withdrawn from the hand by a player or that new cards have been substituted. A unique code also placed on each card is read as the card is dealt to indicate the value and the suit. The game control stores this information in a memory so that a history of each card dealt is recorded. Sensors are located near each of the player positions for sensing the presence of a game bet and a progressive bet. A card sensor located near each player position and the dealer position issues a signal for each card received. The game control receives these signals and correlates those player positions having placed a game and/or progressive bet with the received cards. The game control at each table has stored in memory the winning combinations necessary to win the progressive jackpots. Since the game control accurately stores the suit and value of each card received at a particular player position, the game control can automatically detect a winning progressive combination and issue an award signal for that player position. The shoe element has the card-reading components in the card withdrawal area. When integrated into a shuffling device, a camera may capture images at various positions before and at the delivery area.

U.S. Pat. No. 6,250,632 to Albrecht describes an apparatus and method for sorting cards into a predetermined sequence. One embodiment provides a deck holding area in which cards are held for presenting a card to a read head for reading the characters on the face of the card. The apparatus also has a tray having a sequence of slots and a card-moving mechanism for moving the presented card from the deck holding area into one of the slots. The tray is connected to a tray-positioning mechanism for selectively positioning the tray to receive a card in one of the slots from the card-moving mechanism. A controller is connected to the read head, the card-moving mechanism, and the tray-positioning mechanism. The controller controls the reading of each of the cards by the read head and identifies the value of each card read, and also controls the card-moving mechanism to move each of the cards to a slot of the tray positioned by the tray-positioning mechanism according to the predetermined sequence of values. The method for sorting includes the steps of providing a tray having a sequence of slots, determining a predetermined sequence of values for the cards, and reading the face of a card to determine the value the card. The method further includes moving the read card into one of the slots of the tray. The position of the slot into which the read card is moved corresponds to the position of the value in the predetermined sequence.

U.S. Pat. No. 6,267,248 to Johnson et al. describes a collation and/or sorting apparatus for groups of articles. The apparatus is a sorting and/or shuffling device for playing cards. As shown in FIG. 2 of Johnson, the apparatus comprises a sensor (15) to identify articles for collation and/or sorting, and a feeding means (14) to feed cards from a stack (11) past the sensor (15) to a delivery carriage (18) adapted to deliver cards individually to a preselected one of a storing space (24) in an indexable magazine (20). A microprocessor (16) coupled to the feed means (14), delivery carriage (18), sensor (15) and magazine (20) determines according to a preprogrammed routine whether cards identified by sensor (15) are collated in the magazine (20) as an ordered deck of cards or a randomly ordered or “shuffled” deck or decks.

U.S. Pat. No. 6,361,044 to Block et al. describes a system with a top of a card table having a card-dispensing hole therethrough and an arcuate edge covered by a transparent dome-shaped cover. A dealer position is centrally located on the tabletop. A plurality of player stations is evenly spaced along the arcuate edge. A rotatable card placement assembly includes an extendable arm that is connected to a card carrier that is operable to carry a card. In response to signals from the computer, the rotation of the assembly and the extension of the arm cause the card carrier to carry the card from the card-dispensing hole to either the dealer position or any of the player positions. The card carries bar code identification thereon. A bar code reader of the card carrier provides a signal representation of the identification of the card to the computer.

U.S. Pat. No. 6,403,908 to Stardust et al. describes an automated method and apparatus for sequencing and/or inspecting decks of playing cards. The method and apparatus utilize pattern-recognition technology or other image-comparison technology to compare one or more images of a card with memory containing known good images of a complete deck of playing cards to identify each card as it passes through the apparatus. Once the card is identified, it is temporarily stored in a location corresponding to or identified according to its position in a properly sequenced deck of playing cards. Once a full set of cards has been stored, the cards are released in proper sequence to a completed deck hopper. The method and apparatus also include an operator interface capable of displaying a magnified version of potential defects or problem areas contained on a card, which may then be viewed by the operator on a monitor or screen and either accepted or rejected via operator input.

This patent requires identification of cards and storage of cards with the identity of the card recognized in a storage position. The cards are read and then stored in identified and recoverable positions. The identified cards are then directed, in ranked and suited order, into a final collection area where the ordered deck is formed.

U.S. Pat. No. 5,779,546 to Meissner et al. describes a method and apparatus enabling a game to be played based upon a plurality of cards. An automated dealing shoe dispenses each of the cards and recognizes each of the cards as each of the cards is dispensed. Player stations are also included. Each player station enables a player to enter a bet, request that a card be dispensed or not dispensed, and to convert each bet into a win or a loss based upon the cards that are dispensed by the automated dealing shoe. This patent requires a system organization (betting and card calling functions at each player position and win-tracking as a result of play). The dealer shoe reads the cards one at a time when driven by a single drive wheel into the card read station. The cards are fed from a sloped tray and are moved at a constant speed to enable accurate reading of the cards.

U.S. Pat. No. 6,217,447 to Lofink et al. describes a method and system for generating displays related to the play of baccarat. Cards dealt to each of the banker's and player's hands are identified as by scanning, and data signals are generated. The card identification data signals are processed to determine the outcome of the hand. Displays in various formats to be used by bettors are created from the processed identification signals, including the cards of the hand played, historical records of outcomes, and the like. The display can also show bettors' expected outcomes and historical bests. Bettors can refer to the display in making betting decisions.

The cards are read between the shoe and the player positions. In reference to FIG. 2 of Lofink et al., “Disposed between the shoe 22 and areas 24, 26 are means for identifying the cards dealt to the player and banker hands. These means are embodied as any suitable card scanner 32. Scanner 32 optically scans each card 10 as it is dealt from the shoe 22 and swiped across the scanner 32, face down. When the cards 10 include a bar code (not shown) on their face, which designates suit and denomination, the scanner 32 may be a laser scanner adapted to generate signals corresponding to the bar code. Preferably, to avoid the necessity of bar coding cards, the scanner 32 is of the type, which optically scans the card face and generates data signals corresponding to the optical characteristics of the face of the card. As but an example, digital camera means can be used to generate data signals, broken in picture elements, i.e., pixels, the signal strength at the locations of the individual pixels collectively corresponding to the actual appearance of the face.”

U.S. Pat. No. 5,605,334 to McCrea, Jr., is believed to disclose a distinct card-reading element/section/attachment to a card shuffler. The disclosure, though technically enabling in some respects, appears to be mainly prophetic, and when read in combination with U.S. Pat. No. 5,356,145 (Verschoor, which discloses the “shuffler”), technical deficiencies are clearly apparent. The patent specification describes a complete table system and does not include a card-reading discard rack. FIG. 16 of the McCrea, Jr., patent is an illustration setting forth the addition of a single reader to the automatic shuffler of U.S. Pat. No. 5,356,145 (Verschoor, Nationale Stichting tot Exploitatie van Casinospelen in Nederland (Hoofddorp, NL)). The shuffler is a simple card-interleaving system with cards fed nearly consecutively from two separate stacks.

In FIGS. 16 and 17 of McCrea, Jr., is set forth another embodiment of a secure shuffler. Again, this shuffler is based upon the structure set forth in U.S. Pat. No. 5,356,145. “The shuffler 240 is mounted on a base 1600 in which is contained a camera 1610 with a lens 1620. Hence, this embodiment is self-contained and is not mounted to the table. In this embodiment, a single camera is used to record optical images of the cards dealt (as indicated by arrow 1602) and cards inserted (as indicated by arrow 1604). The inserted cards are placed in stack 93a and the cards dealt are dealt from stack 1230. Hence, in FIG. 16, a card 1230B is placed in the modified shoe 250 and an image is delivered as shown by arrow 1630 into a mirror 1632 and is reflected 1634 into a central mirror 1636. Likewise, card 1410B is in stack 93a or is delivered into stack 16a, by drive disk 37a, an image 1640 is delivered into mirror 1642 and is reflected 1644 into the central mirror 1636. The lens 1620 receives the reflected signals 1646 from mirror 1636 and delivers these optical images over lines 252 to the game control. It is to be expressly understood that images 1630 and 1640 can be obtained from a number of regions internal to shuffler 240 and that mirrors other than mirrors 1632, 1646 and 1642, can be used to reflect images into lens 1620.”

U.S. Pat. No. 5,669,816 to Garczynski et al. describes a “no peek” module for announcing when a dealer has blackjack without exposing the face of the dealer's down card. The module scans a character from the dealer's face-down standard playing card, compares the result of the scan with a set of references, and identifies the down card. The module also receives input from the dealer as to the identity of the dealer's up card, and announces whether the dealer has blackjack or the hand continues. The module is designed to be mounted to a blackjack table, such that the surface of the module on which the standard playing card rests while being scanned is in the plane of the surface of the blackjack table, allowing the dealer to slide the down card across the table and onto the scanner without lifting, and potentially exposing, the card's face. The module also removes the noise generated by a casino's heat, dust, cigarette and cigar ashes, and lint from the felt of the blackjack table, during the scanning process. The module further optimizes the scan of the character on the standard playing card by controlling the light intensity emitted by the components of the module used to illuminate the character.

U.S. Pat. No. 5,772,505 to Garczynski et al. describes a “no peek” dual card-scanning module that announces when the symbols of a face-up standard playing card and a face-down standard playing card achieve a desired combination. The module has a scanner system that illuminates and scans at least a portion of a symbol of the face-up standard playing card and at least a portion of a symbol of the face-down standard playing card and stores the results thereof in a first and second array device, respectively. The module also has a guide to assist in receiving and positioning the cards, such that the face-up standard playing card is above and aligned with the face-down standard playing card. When in this position, the symbol portions of the face-up and the face-down standard playing cards can be scanned by the array devices to generate respective scanning results. The module compares the scanning results with a memory storing a plurality of references representing respective symbols of the standard playing cards to determine if the cards have achieved the desired combination. This system requires the reading of both the face-up and face-down cards. After review of the specification, it is believed that this requirement is to be read as reading those cards in the specific positions as face-up and face-down cards and does not include reading the cards as they are withdrawn from a shoe. There is also the requirement of a display. This displays/indicates blackjacks by identification of the dealer's hole card and an up card while it is at the dealer's position. The card is not read in the discard rack after the play of the game, but at the dealer's hand position before or during the game.

U.S. Pat. Nos. 6,039,650 and 5,722,893 to Hill describe a card-dealing shoe that has a card reader/scanner, which scans indicia on a standard playing card as the card moves along and out of a chute by manual direction by the dealer in the normal fashion. The scanner can be one of several different types of devices, which will sense each card as it is moved downwardly and out of the shoe. A feed-forward neural network is trained, using error back-propagation to recognize all possible card suits and card values sensed by the scanner. Such a neural network becomes a part of a scanning system that provides a proper reading of the cards to determine the progress of the play of the game, including how the game might suffer if the game players are allowed to count cards using a card count system or perform other acts that would limit the profit margin of the casino. An LCD display can also be part of the shoe, and this display can be used to enter and retrieve vital player information as deemed necessary or desirable to the customer file opened when the magnetic stripe reader reads the preferred customer card with the customer name and account number embedded within the card's magnetic stripe. Scanned information is fed to a computer for extensive analysis.

U.S. Pat. No. 6,126,166 to Lorson et al. describes a system for monitoring play of a card game between a dealer and one or more players at a playing table, including a card-dispensing shoe comprising one or more active card-recognition sensors, and a signal-processing subsystem. The system gathers information on the distribution of cards in a dealing shoe from knowledge of the sequence of cards dealt during game play. When signaled, the system determines the appropriate sequence, number, and positions of the pre-shuffle plug locations of the cards in the discard shoe. The system transmits the pre-shuffle card plug information to an output device driver assembly, which actuates the desired output devices. In one implementation, the system output devices are light-emitting diodes, but any number of electric, acoustic, or mechanical devices could be utilized. The dealer plugs the card segments as directed by the system output devices and signals completion by operating the control switch discussed above. The process is repeated until the card segments are properly positioned, and then the system transmits an output signal to direct the dealer to shuffle the cards.

U.S. Pat. No. 5,941,769 to Order describes an apparatus for use in table card games. The device is for professional use in table games of chance with playing cards and gaming chips (jettons), in particular, the game of blackjack. The object of the invention is to provide an automatically working apparatus, which will register and evaluate all phases of the run of the game automatically. This is achieved by a card shoe with an integrated device for recognition of the value of the drawn cards (3′) (optical recognition device and mirroring into a CCD image converter); photodiodes (52) arranged under the table cloth (51) in order to register separately the casino light passing through each area (53, 54) for placing the gaming chips (41) and areas (55, 56) for placing the playing cards (3) in dependence of the arrangement or movement of the jettons and playing cards on the mentioned areas; a device for automatic recognition of each bet (e.g., a scanner to register the color of the jettons, or an RFID system comprising an S/R station and jettons with integrated transponders); an EDP program created in accordance with the gaming rules to evaluate and store all data transmitted from the functional devices to the computer; and a monitor to display the run of the game and players' wins.

At the Global Gaming Expo 2002, held at the Las Vegas Convention Center in Las Vegas, Nev., MindPlay LLC displayed a complete blackjack table game-monitoring system in the Bally Gaming booth. That system read cards from a tray prior to and after dealing, and read chips on the table with a camera. It was absolutely clear that the cards read in the tray had to be edge marked, as the cards were read without being sufficiently fanned out to display the faces of the individual cards. As all the cards were read at one time, there must have been edge-reading capability. This is confirmed in U.S. Pat. No. 6,460,848, which claims and enables this edge-reading capability. Cards were deposited in the tray for verification after play of the hand, again by edge reading (that is, the cards were sloped in a set so that special coded markings on the faces or backs of the cards could be read to identify the suit and rank of the cards; standard decks could not be used in the displayed systems). Only single-deck capability was possible at the time. It is not known how the software specifically related to the verification of the original deck, especially with regard to discards, double downs, etc., but some accommodation to that play was apparent in the play of the game on the displayed table.

Among the more assertive systems for blackjack (and other table game) security that have been disclosed and marketed is the MindPlay LLP casino table security system represented by U.S. Pat. Nos. 6,533,662; 6,533,276; 6,530,837; 6,530,836; 6,527,271; 6,520,857; 6,517,436; 6,517,435; and 6,460,848.

U.S. Pat. No. 6,460,848 to Soltys particularly deals with playing card-reading systems and describes a system that automatically monitors playing and wagering of a game, including the gaming habits of players and the performance of employees. A card deck reader automatically reads a symbol from each card in a deck of cards before a first one of the cards is removed from the card reader. The symbol identifies a respective rank and suit of the card. In actual use, the complete set (e.g., deck or decks) of cards is removed from the card-reading tray and dealt by hand. A chip tray reader automatically images the contents of a chip tray to periodically determine the number and value of chips in the chip tray, and to compare the change in contents of the chip tray to the outcome of game play for verifying that the proper amounts have been paid out and collected. A table monitor automatically images the activity occurring at a gaming table. Periodic comparisons of the images identify wagering, as well as the appearance, removal, and position of cards and other game objects on the gaming table. A drop box automatically verifies an amount and authenticity of a deposit and reconciles the deposit with a change in the contents of the chip tray. The drop box employs a variety of lighting and resolutions to image selected portions of the deposited item. The system detects prohibited playing and wagering patterns, and determines the win/loss percentage of the players and the dealer, as well as a number of other statistically relevant measurements. The measurements provide automated security and real-time accounting. The measurements also provide a basis for automatically allocating complimentary player benefits.

The operation of the Soltys card-reading system is described as feeding of the cards into the storage area of the rack and exposing them to reading sensors that read an edge of the cards. That system reads cards after they are put into a cradle (which is a housing sized for receiving playing cards), and therefore reads all of the cards (a plurality of cards) before a first card is removed from the cradle.

WO 00/51076 and U.S. Pat. No. 6,629,894 to Purton and assigned to Dolphin Advanced Technologies Pty. Ltd., describe a card-inspection device having a loading area on an elevator to receive one or more decks of playing cards. A drive (e.g., feed roller) presents cards from a loading area into a card accumulation area. The card passes over a camera in the transition between areas to sense the suit and rank of the cards. The system reverses the order of the cards from the loading area to the collection area. A printer produces a record of the device's operation.

None of the references discussed above describe a discard rack that reads cards individually as the cards are collected from the table at the conclusion of play, or reads decks or groups of decks of cards to verify that the deck or decks are complete prior to the next use.

### BRIEF SUMMARY

A smart discard rack (also referred to for purposes of this disclosure as a “card verification station”) is used to read information from a card set to identify the rank and suit of cards. In one form of the invention, all cards in the set of playing cards (comprising one or more regular or special decks of playing cards) are fed through the smart discard rack between rounds of play to verify that the decks are complete. In another form of the invention, groups of playing cards are fed through the card verification station prior to commissioning or after play and prior to decommissioning the playing card set for play on the casino floor. In a third form of the invention, the card verification station is used as a part of a system for identifying the composition of a hand or hands of playing cards at the conclusion of a round of play, the playing cards are first read as they are distributed to players (by a first separate reading device or system), and when they are returned to the smart discard rack in a particular pattern of collection from the table. The smart discard rack information can be used in conjunction with original card set suit and rank information to define elements of play (for example, to reconstruct blackjack hands) in the casino table card game.

### BRIEF DESCRIPTION OF THE DRAWINGS

FIG. 1 shows a side cutaway view of a smart discard rack according to an embodiment of the present invention.

FIG. 2 shows a top cutaway view of a smart discard rack according to an embodiment of the present invention.

FIG. 3 shows an end cutaway view of a smart discard rack according to an embodiment of the present invention.

FIG. 4 shows a side cutaway view of another perspective of a smart discard rack according to the presently described technology.

FIG. 5 shows a casino card gaming table equipped with a data collection module capable of tracking a number of rounds of play on the table per a given unit of time.

FIG. 6 is a flow diagram of an optical round-counting system.

FIG. 7 is a schematic diagram of a card verification station and associated equipment used to check decks of cards.

### DETAILED DESCRIPTION OF THE INVENTION

Groups of cards, including hands, partial hands, community cards, dealer hands, decks of cards, and multiple decks of cards, may be verified using the card verification station of the present invention. The card verification station may be utilized as a separate stand-alone device for confirming the composition of groups of cards prior to commissioning them for play on the casino floor, as part of a decommissioning process after play, or as part of a table game-monitoring device. For example, card hands and card play may be read by a system that comprises a card-reading delivery shoe and a card-reading discard rack (also referred to in this disclosure as a card verification station) of the present invention. The term “smart” is used with respect to components in the system because of their use or connection to memory and processing and/or storage intelligence (e.g., microprocessors, processors, and computers) and the use of that processing and/or storage intelligence in the practice of processes according to the teachings of the invention.

A smart card delivery shoe (which may be a stand-alone unit or a component of a randomization device) is used that reads the suit and rank of each card before it is delivered to the various positions where cards are to be dealt in the play of the casino table card game. The cards are then dealt according to the rules of the particular game to the required card positions. Different games have diverse card distribution positions, different card numbers, and different delivery sequences that the hand-identifying system of the invention must encompass. For example, in the most complex of card distribution games of blackjack, cards are usually dealt in sequence around a table, one card at a time to each player position and then to the dealer position. The one card at a time delivery sequence is again repeated so that each player position and the dealer position have an initial hand of exactly two cards each. Complexity in hand development is introduced because players have essentially unlimited control over additional cards received, at least until the point value in a hand exceeds a count of 21. Players may stand with a count of 2 (two aces) or take a hit with a count of 21 if they are so inclined, so the knowledge of the count of a hand is no assurance of what a player will do. The dealer, on the other hand, is required to follow strict house rules on the play of the game according to the value of the dealer's hand. Small variances such as allowing or disallowing a hit on a “soft” 17 count (e.g., an Ace and a 6), may exist, but the rules are otherwise very precise so that the house or dealer cannot exercise any strategy.

The presently described technology may be used as a component of a more complex system that identifies the composition of each individual hand at a table when a player can use discretion in taking cards, without having to provide card-reading sensors at every player position or an overhead camera to read every card at the table. Even those expensive systems are susceptible to manipulation or fraud and do not provide maximum security.

Some cards games may provide equal numbers of cards in batches. The player has no control over the number of cards in the hand. Variants of stud poker played against a dealer, for example, would usually provide hands of three, four or five cards, three, four or five at a time, respectively, to each player position and, if competing against a dealer, to the dealer position. This card hand distribution is quite simple to track as each sequence of cards removed from the dealer shoe is a hand, or as each hand of cards is fed into a card verification station at the conclusion of play.

Other games may require cards to be dealt to players and other cards dealt to a “flop,” or common card area. The system including the card verification station should also be programmable to cover this alternative if it is so desired. Other games may not provide the dealer with the dealer cards, or community cards. In this instance, other methods to designate the last hand dealt are needed.

Baccarat is closer to blackjack in card sequence of dealing, but has more rigid rules as to when hits may be taken by the player and the dealer, and each position may take a maximum of one card as a hit. The hand identification system used in connection with the card verification station must be able to address the needs of identifying hands in each of these types of games, and especially must be able to identify hands in the most complex situation, the play of blackjack.

The general operation of an exemplary system incorporating the card verification station of the present invention will be described, and the examples of specific implementations (e.g., smart delivery shoes, smart discard tray, software, computers, components and subcomponents) are intended to be merely exemplary and are not to be read as limiting in the scope of practice of the invention. For example, where cameras are used to read cards, the light-sensitive system may be any image capture system, digital or analog, that is capable of identifying the suit and rank of a card.

### Card Verification as Part of a System for Reconstructing Hands

A first step in the operation is to provide a set of cards to a smart delivery shoe (a shoe capable of reading rank and suit of cards that are removed from the shoe, either before, during or after physical removal of the cards), the cards being those cards to be used in the play of a casino table card game. The set of cards (usually one or more decks) is provided in an already randomized set, being taken out of a multiple-deck batch shuffler or having been shuffled by hand. A preferred smart delivery shoe is described in U.S. patent application Ser. No. 10/622,321, filed Jul. 17, 2003, titled PLAYING CARD DEALING SHOE WITH AUTOMATED INTERNAL CARD FEEDING AND CARD READING, which is incorporated herein in its entirety by reference for its entire disclosure of the card reading and delivery capability, the structure of that device and all enabling disclosure therein. Alternative but less-preferred card delivery systems or shoes with reading capability include, but are not limited to, those disclosed in U.S. Pat. Nos. 4,750,743; 5,779,546; 5,605,334; 6,361,044; 6,217,447; 5,941,769; 6,299,536; 6,460,848; 5,722,893; 6,039,650; and 6,126,166. Some of these systems require specially coded cards, which are particularly undesirable, but may be used as an alternative. The cards are read in the smart card delivery shoe, preferably one card at a time in sequence. Reading cards by edge markings and special codes (as described in U.S. Pat. No. 6,460,848) requires special encoding and marking of the cards. The entire sequence of cards removed from the shoe is thus determined and stored in memory. Memory may reside at least in part in the smart delivery shoe, but communication with a central processor is highly desirable and preferred. The read sequence would then also, or solely, be stored in the central computer. If it is desired to obtain the entire sequence of cards prior to dispensing cards, the group of cards can be randomized and/or scanned in a shuffler such as the device disclosed in U.S. patent application Ser. No. 10/623,223, filed on Jul. 17, 2003, titled CARD SHUFFLER WITH CARD RANK AND VALUE READING.

The cards are then dealt out of the smart delivery shoe, the delivery shoe registering the card rank and suit as well as how many cards are removed one at a time. This is easily accomplished by the above-identified U.S. patent application Ser. No. 10/622,321 (and less preferably by the above-identified U.S. patents) where cards are fed to the dealer removal area one at a time, so only one card can be removed at a time by the dealer. As each card is removed from the shoe, a signal is created indicating that a specific card (of rank and suit) has been dealt. The computer and system know only that a first card has been dealt, and it is presumed to go to the first player. The remaining cards are dealt out to players and dealer. In the play of certain games (e.g., stud poker variants) where specific numbers of cards are known to be dealt to each position, the shoe may be programmed with the number of players at any time, so hands can be correlated even before they have been dealt. If a stud poker variant is being played, where each player and the dealer get three cards (THREE CARD POKER® game), the system will know in advance of the players what each player and the dealer will have as a hand. It is also possible that there be a signal available (particularly desirable in blackjack) when the dealer has received either his first card (e.g., when cards are dealt in sequence, one at a time) or has received his entire hand. The signal is desirable as that signal can be readily used to automatically determine the number of player positions active on the table at any given time. For example, if in a hand of blackjack the dealer receives the sixth card, the system will immediately know that there are five players at the table. The signal can be given manually (e.g., pressing a button at the dealer position or on the smart card delivery shoe) or can be provided automatically (e.g., a card presence sensor at the dealer's position, where a card can be placed over the sensor to provide a signal). Where an automatic signal is provided by a sensor, some physical protection of the sensor is preferably provided, such as a shield that would prevent accidental contact with the sensor or blockage of the sensor. An L-shaped cover would be very desirable, so that a card could be slid under the arm of the L parallel to the table surface and cover the sensor under that branch of the L. The signal can also be given after all cards for the hand have been delivered, again indicating the number of players. For example, when the dealer's two cards are slid under the L-shaped cover to block or contact the sensor, the system will know the total number of cards dealt on the hand (e.g., ten cards), know that the dealer has two cards, determine that players therefore have eight cards, and know that each player has two cards, thereby absolutely determining that there are four active player positions at the table (10−2=8 player cards and then 8/2=4 players). This automatic determination is highly desirable as opposed to having dealers input the number of players at a table for each hand or having to manually change the indicated number of players at a table each time the number changes. The use of a dealer activation device or completely automatic signal-generating device likely would be needed in cases where the dealer does not receive cards, although information-based input (such as a timed period of cessation of delivery of cards or the input of cards to a discard rack) could be used to indicate the end of the delivery of cards in a round of play.

Once all cards have been dealt, the system knows what cards are initially present in each player's hand, the dealer's hand, and any flop or common hand. The system operation is now simple when no more cards are provided to play the casino table game. All hands are then known and all outcomes can be predicted. The complication of additional cards will be addressed with respect to the game of blackjack.

After dealing the initial set of two cards per hand, the system cannot immediately know where each remaining card will be dealt. The system does know what cards are dealt, however. It is with this knowledge and a subsequent identification of discarded hands that the hands and cards from the smart delivery shoe can be reconciled or verified. Each hand is already identified by the presence of two specifically known cards. Hands are then played according to the rules of the game, and hands are discarded when play of a hand is exhausted. A hand is exhausted when: 1) there is a blackjack, the hand is paid, and the cards are cleared; 2) a hand breaks with a count over twenty-one and the cards are cleared; and/or 3) a round of the game is played to a conclusion, the dealer's hand is completed, all wagers are settled, and the cards are cleared. As is typically done in a casino to enable reconciling of hands manually, cards are picked up in a precise order from the table. The cards are usually cleared from the dealer's right to the dealer's left, and the cards at each position comprise the cards maintained in the order that they were delivered, first card on the bottom, second card over the first card, third card over the second card, etc., maintaining the order or a close approximation of the order in which they were delivered (e.g., the first two cards may be reversed). Maintaining the order is important, as the first two cards form an anchor, focus, basis, fence, and end point or otherwise define a set edge for each hand. For example, if the third player position was known to have received the 10 of hearts (10H) and the 9 of spades (9S) for the first two cards, and the fourth player was known to receive the 8 of diamonds (8D) and the 3 of clubs (3C) for the first two cards, the edges or anchors of the two hands are 9S/10H and 8D/3C. When the hands are swept at the conclusion of the game, the cards are sent to the smart discard rack of this invention and the swept cards consist of 9S, 10H, 8S, 8D and 3C (as read by the smart discard rack), the software of the processor will automatically know that the final hands in the third and fourth positions were a 9S and 10H for the third hand 8D and 3C originally plus the 8S hit for the fourth hand. The analysis by the software specifically associates the extra card with the fourth hand with the specific cards read by the smart discard rack. The information from reading the exhausted hands is compared with the original information collected from the smart delivery shoe. The smart delivery shoe information, when combined with the smart discard rack information, confirms the identity and composition of each hand, even when cards are not uniformly distributed (e.g., player one takes two hits for a total of four cards, player two takes three hits for a total of five cards, player three takes no hit for a total of two cards, player four takes one hit for a total of three cards, the player splits hands, and the dealer takes two hits for a total of four cards). If fewer than all player positions are occupied, a position sensor or bet sensor could be used to associate the hand with a particular hand position. An example of one chip-sensing system is disclosed in Schubert U.S. Pat. No. 6,313,871, the content of which is incorporated herein by reference.

The dealer's cards may be equally susceptible to analysis in a number of different formats. After the last card has been dealt to the last player, a signal may be easily and imperceptibly generated that the dealer's hand will now become active with possible hits. For example, with the sensor described above for sensing the presence of the first dealer card or the completion of the dealer's hand, the cards would be removed from beneath the L-shaped protective bridge. This type of movement is ordinarily done in blackjack where the dealer has at most a single card exposed and one card buried face down. In this case, the removal of the cards from over the sensor underneath the L-cover to display the hole card is a natural movement and then exposes the sensor. This can provide a signal to the central processor that the dealer's hand will be receiving all additional cards in that round of the game. The system at this point knows the two initial cards in the dealer's hand, knows the values of the next sequence of cards, and knows the rules by which a dealer must play. The system knows what cards the dealer will receive and what the final total of the dealer's hand will be, because the dealer has no freedom of decision or movement in the play of the dealer's hand. When the dealer's hand is placed into the smart discard rack, the discard rack already knows the specifics of the dealer's hand even without having to use the first two cards as an anchor or basis for the dealer's hand. The cards may be treated in this manner optionally, but it is not essential.

When the hands are swept from the table, dealer's hand then players' hands from right to left (from the dealer's position or vice-versa if that is the manner of house play), the smart discard rack reads the playing cards and identifies the anchors for each hand, and the computer identifies the individual hands and reconciles them with the original data from the smart delivery shoe. The system thereby can identify the composition of each hand played (i.e., number of cards, rank and suit of each card, etc.) and provide system assurance that the hand was played fairly and accurately.

If a lack of reconciling by the system occurs, a number of fault events can occur. A signal can be given directly to the dealer position, to the pit area, or to a security zone, the cards can be examined to determine the nature of the fault and cause of the error, and individual cards can be inspected if necessary. When the hand and card data are being used for various statistical purposes, such as evaluating dealer efficiency, dealer win/loss events, player efficiency, player win/loss events, statistical habits of players, unusual play tactics or meaningful play tactics (e.g., indicative of card counting), and the like, the system may file the particular hand in a “dump” file so that hand is not used in the statistical analysis. This is to assure that maximum benefits of the analysis are not tilted by erroneous or anomalous data.

A review of the figures will assist in a better understanding of the discard rack and card verification station apparatus and method of the present invention.

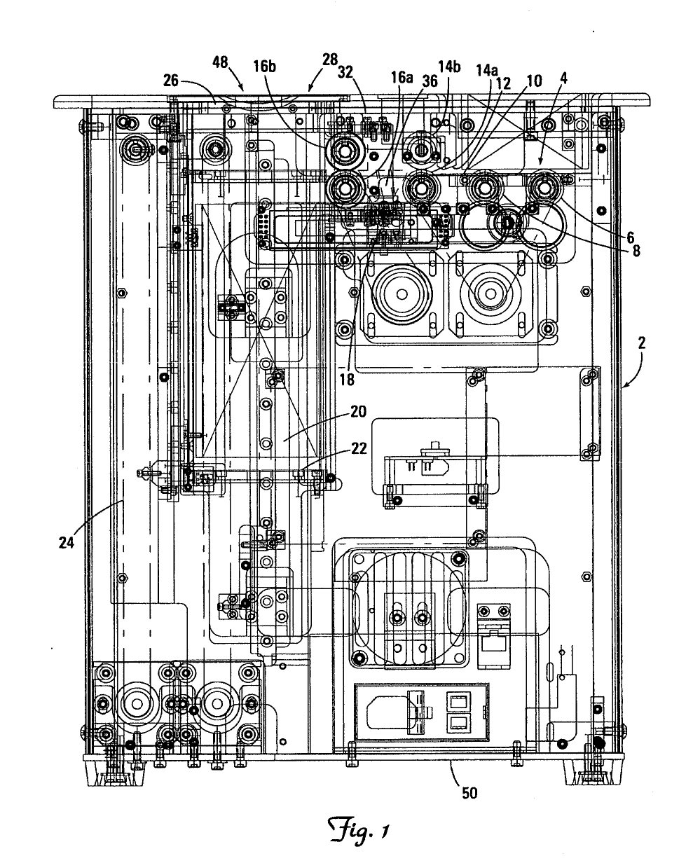

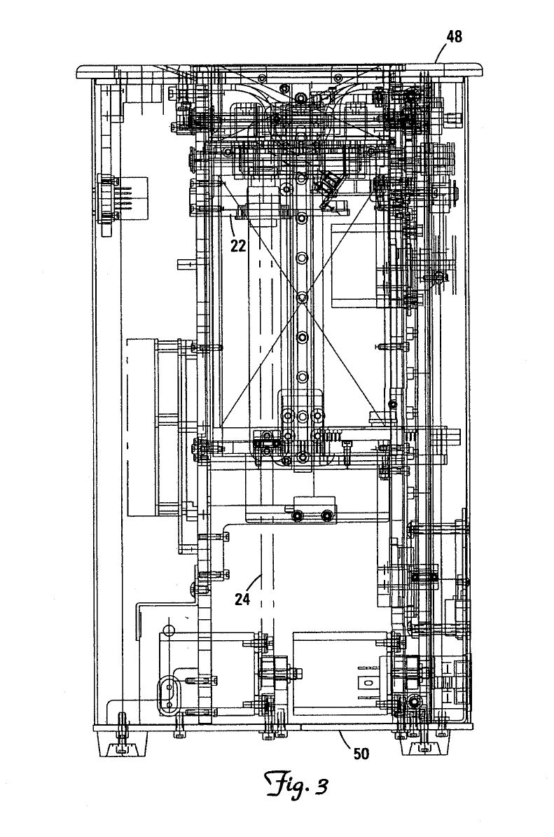

FIG. 1 shows a side cutaway view of a smart discard rack 2 of one embodiment of the present invention. The following discussion can be best understood by referring to both FIGS. 1 and 3. The smart discard rack 2 has a hand insert area 4 comprising a card-receiving well where cards are inserted (e.g., one hand at a time, or one card at a time, or groups of exhausted or unused cards in a batch or entire batches of cards), usually after the completion of play in a casino table card game. Pick-off rollers 6 and 8 move cards individually and horizontally from the bottom of the stack of cards (not shown) in the hand insert area 4 one at a time through opening 10 from the hand insert area 4. A sloped or beveled face 12 is provided to assure proper horizontal orientation of moving cards and to prevent jamming at this position.

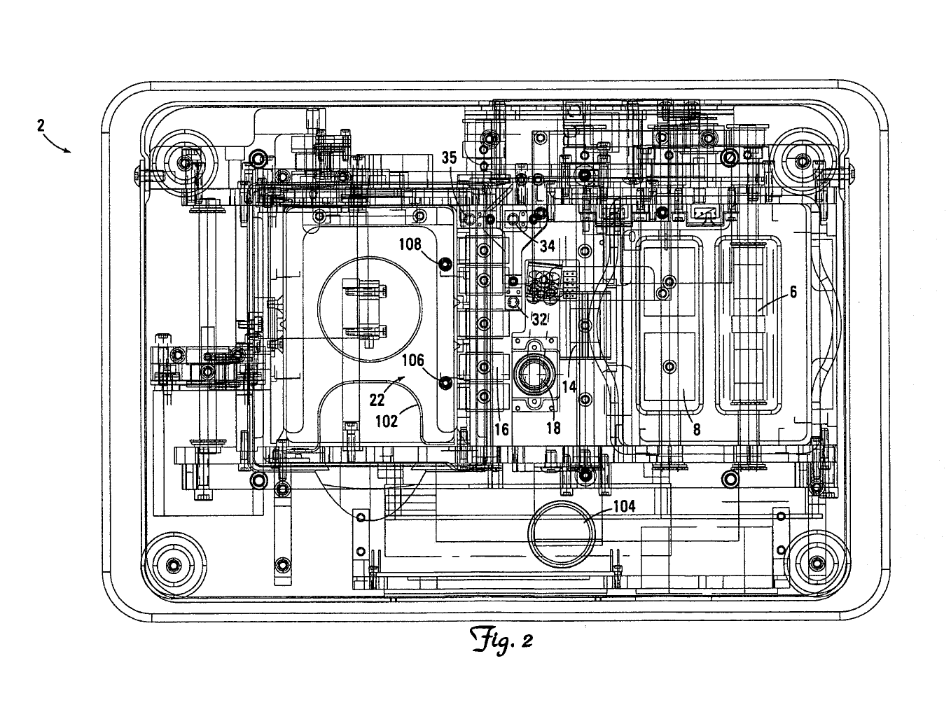

After an individual card is moved through the opening 10, a first additional set of nip rollers 14a and 14b (which may be referred to as brake rollers, or first nip rollers 14) engages and directs the card. When the card (not shown) is between the first set of nip rollers 14a and 14b, and a second set of nip rollers 16a and 16b (which may be referred to as speed-up rollers 16), the cards are positioned with their card faces (with suit and rank symbols) facing downwardly to the bottom 50 of the smart discard rack 2. An image capture device 18 which is capable of reading the symbols on the cards, and especially standard suit and rank symbols on the corners of the cards, is positioned to read the intended symbols on the cards are positioned above and between the first set of nip rollers 14a and 14b, and the second set of nip rollers 16a and 16b to sense the position of cards. The image capture device 18 may be in other locations (such as on the side of the card or below the card or at an angle) if desired. Sensors 32 (FIGS. 1 and 2) and sensor 34 (FIG. 2) signal the position of edges of the cards as they are moved. Additional sensors (not shown) may be present in other locations, such as in the hand insert area 4 and in a card collection area 20. The sensors 32 and 34 indicate when the individual cards to be read will be in a desired or optimum position for symbols on the card to be read by image capture device 18. For example, to conserve memory in the computer and reduce information flow, it would be desirable to limit image information to the symbols of each card, rather than having the camera image and report a constant stream of data on the entire face of each card and the empty space between cards. For example, when sensor 34 indicates the presence of a new edge of a card, the image capture device 18 will be triggered and a snapshot taken. The focal point or focal plane 36 of the image capture device 18 will encompass the symbols to be read on the card, usually only the upper left hand corner of a playing card. The symbol will be imaged and the data from the image read by available image reading software.

A desirable set of image capture devices (e.g., a CCD camera) and sensors (e.g., light-emitting devices and light capture devices) will be described, although a wide variety of commercial technologies and commercial components are available. A preferred camera is the “DRAGONFLY®” camera provided by Point Grey Research Inc. of Canada, 305-1847 West Broadway, Vancouver, BC, Canada V6J 1Y6 and includes a 6-pin IEEE-1394 interface, asynchronous trigger, multiple frame rates, 640×480 or 1024×724 24-bit true color or 8-bit gray scale images, image acquisition software and plug-and-play capability. This can be combined with commercially available machine vision software. The commercially available machine vision software is trained on card symbols and taught to report image patterns as specific card suits and ranks. An example of one type of software that can be used for this purpose is called Evision by Euresys. Once a standard card suit/rank recognition program has been developed, the training from one format of cards to another becomes more simply affected and can be done at the casino table or by a security team before the smart discard rack 2 is placed on the table. Position sensors (e.g., 32 and 34) can be provided and enhanced by one of ordinary skill in the art from commercially available components that can be fitted by one ordinarily skilled in the art. For example, various optics such as SICK® WT2S-N111 or WL2S-E11; OMRON® EE SPY302; or OPTEK® OP506A may be used. A useful encoder can be purchased as US Digital encoder 24-300-B. An optical response switch can be provided as MICROSWITCH™ SS541A.

Once the symbol has been imaged, a signal is sent to a central processor where the information of the suit and rank of the individual cards is processed according to the objectives of the system. In one form of the invention, the processor is part of the discard rack. In another form, the processor is a separate game computer or casino host computer, and the information is first collected in a database (not shown) prior to being analyzed. After each card has been read, the individual cards values are stored, and the discard rack processor or a separate game computer or casino host computer moves the read card by rollers 16a/16b to be deposited in the card collection area 20. Cards are delivered into the card collection area 20 by being placed on a support tray 22. The height of the support tray 22 is adjusted by belt drive 24 so that the top card (not shown) on the tray 22 or the surface of the tray 22 if no cards are present, is slightly below the level at which cards are fed from rollers 16a/16b into the card collection area 20. This prevents cards from having to fall onto a collection of cards and possible upturning or standing on edge. The support tray 22 is preferably moved in only a single direction (downwardly) as individual cards are fed into the card collection area 20. By maintaining the identical order of cards fed from the hand insert area 4 to the card collection area 20, manual reconciling of hands or game play can be enabled.

After all cards have been delivered to the card collection area 20, the support tray 22 is elevated to expose the set of cards through an opening 26 at the top 48 of the smart discard rack 2. There may be a manually operable or an automatically openable cover 28 over the card collection area so that the set of cards can be raised over the top surface 48 by the elevated support tray 22 and the card set removed, essentially at the elevation of the playing table surface. Preferably the entire device is flush-mounted into an upper surface of the gaming table.

FIG. 2 shows a top cutaway view of an embodiment of the smart discard rack 2 of the present invention. All numbered elements have the same numbers as in FIG. 1 and are the same elements from a different perspective. The support tray 22 is shown with an ergonomic opening 102 to assist in manual removal of cards. Sensors 106 and 108 are used to detect card jams or the like, or to track the number of cards moved through rollers 16 onto the card collection or support tray 22. Button 104 may be an on-off switch or jam recovery switch or the like.

It is always possible for cards to jam, misalign or stick during internal movement of cards through the discard rack. There are a number of mechanisms that can be used to effect jam recovery. The jam recovery may be based upon an identified (sensed) position of jam or may be an automated sequence of events. Where a card jam is specifically identified by the sensed position of a jammed card in the device (and even the number of cards jammed may be estimated by the dimensions of the sensed image), a jam recovery procedure may be initiated at that specific location. A specific location in FIG. 1 within the dealing shoe (e.g., between and inclusive of rollers 14 (i.e., 14a and 14b) and 16 (i.e., 16a and 16b) will be discussed from an exemplary perspective, but the discussion relates to all other positions within the device.

If a card is sensed (e.g., by sensors 106 and/or 108) as jammed between rollers 16a/16b and 114a/14b (e.g., a jam occurs when cards will not move out of the position between the rollers and cards refuse to be fed into that area), one of a various number of procedures may be initiated to recover or remove the jam. Among the various procedures, which are discussed by way of non-limiting example, include at least the following. The rear-most set of rollers (14a and 14b) may reverse direction (e.g., 14a begins to turn clockwise and 14b begins to turn counterclockwise) to reverse a direction of movement of the jammed card and to remove the jammed card from between the rollers (14a and 14b) and have the card extend backwards into the opening 10, without attempting to reinsert a card into the hand insert area 4. The reversed rotation may be limited to assure that the card remains in contact with the rollers 14a and 14b, so that the card can be moved back into progression through the dealing shoe. An optional part of this reversal can include allowing rollers 16a and 16b to become free-rolling to release contact and tension on the card during the reversal. The reversed rotation may be smoothly run or episodic, attempting to jerk a jammed card from its jammed position. If that procedure does not work, or as an alternative procedure, both sets of rollers 16a/16b and 14a/14b may reverse at the same time or in either sequence (e.g., 14a/14b first or 16a/16b first) to attempt to free the jam of a card. When one set of rollers only is turning, it is likely to be desirable to have the other set of rollers in the area of the jam to become free rolling. It is also possible to have the rollers automatically spaced further apart (e.g., by separating roller pairs to increase the gap in the potential nip between rollers) to relieve tension on a card and to facilitate its recovery from a jam. The adjacent pairs of rollers (e.g., 16a, 16b and 14a, 14b) can act in coordination, in sequence, in tandem, in order, independently or in any predefined manner. For example, referring to the roller sets as 14a/14b and 16a/16b, the recovery process may have the rollers act: as a) (14 and 16) at the same time in the same direction); b) (14 and 16) at the same time in opposite directions to assist in straightening out cards; c) (14a/14b then 16a/16b) to have the rollers work sequentially; d) (16a/16b then 14a/14b) to have the rollers work in a different sequence; e) 14 only for an extended time, and then 16 operating alone or together with 14; f) 16 only for an extended time or an extended number of individual attempts and then 14 for a prescribed time, etc. As noted earlier, a non-active roller (one that is not attempting to drive or align cards) may become free-rolling during operation of another roller.

These various programs may be performed at a single jam location in series or as only a single program for jam recovery. In addition, as the card may have been read at the point of the jam or before the jam, the rank and value of the card jammed may be identified and this can be displayed on the display panel on the dealing shoe, on the central computer or on a shuffler connected to the dealing shoe, and the dealer or pit boss may examine that specific card to make certain that neither markings nor damage have occurred on that card, which could either cause further problems with the dealing shoe or shuffler, or could enable the card to be identified when it is in the dealing position in the shoe at a later time. The pit crew can then correct any problem by replacement of that specific card or the entire deck, which would minimize downtime at the card table. Also, if a jam cannot be recovered, the delivery shoe would indicate a jam recovery failure (e.g., by a special light, or sound, or alphanumeric display, for example) and the pit person or dealer would open the device and remove the jam manually.

Individual playing cards (not shown) may be read at one or more various locations within the smart discard rack 2. Information may be read by the card-reading image capture device by either continuous reading of all image data in the card pre-delivery area or by triggered on-off imaging of data in a specific region of cards as the presence of a card is sensed within a pre-delivery (prior to the card collection area) area. For example, optical card presence sensors may activate the camera. This sensor is preferably not a camera. A light source (not shown) may be provided to enhance the signal to the camera sensor. That specific region of the card is preferably on a corner of the card wherein complete value information (and possibly suit information) is readable on the card, such as a corner with value and suit ranging symbols on the card. By using on-off or single-shot imaging of each card, the data flow from the sensor/card-reading element is minimized and the need for larger memory and data transmission capability is reduced in the system.

Information may be transferred from the card-reading elements from a communication port or wire for the sensor/reading element. Cards may be buffered or staged at various points within the discard rack, such as where restrained by rollers 16, so that cards partially extend towards the card collection area 20 past the rollers 16, and the like. Cards may partially overlap in buffering as long as two or more cards are not present between a single set of nip rollers 14, 16 where nip forces may drive both cards forward at the same time.

Among the other notable features of the smart discard rack are at least the following elements: After cards have been read, before or during a deal, the cards are returned after play of a hand to the smart discard rack for reading, storage and ultimately return to a shuffler. Hands can be returned one by one or as a group. The feeding of the cards into the storage area of the rack exposes them to reading sensors that read the face of the card without special markings and retains the relative positioning of the cards (the same order and the same sense (e.g., the bottom card in the insert area is the bottom card in the card collection area)).

The information read in the smart discard rack is correlated (compared by software in a separate processor) to the original information read from the cards (after, before or during the deal and play of the hand) to assist in reconstructing each hand of cards.

One advantage in using the smart discard rack of the present invention is that the number of cards left in the shoe cannot be estimated by viewing a thickness of the stack of the cards in the discard rack. When both the card-reading shoe and card-reading discard rack are used, most of the cards are concealed, providing less total information to a player. Sensors indicate face values (suit and rank) when the card is passed over sensors as individual cards are moved through the rack.

### Card Verification Station on a Gaming Table—Centralized Control

In a second embodiment of the invention, the structure of the card verification station is identical to that of the smart discard rack shown in FIGS. 1-3, except that the programming is modified such that the dealer can feed an entire group of cards (such as one or more deals) used in the play of a game into the card verification station at the beginning or conclusion of a round, a shift, or any other defined time, and obtain an indication that the group of cards is verified.

For example, house rules might require a dealer in a single-deck blackjack game to gather all cards from the previous round of play, combine the cards with unused cards from the deck, and insert the cards into the card verification station for reading. Once the rank and suit of each card in the deck has been verified, the processor (internal or external) will initiate a comparison between the cards present and stored data of the correct composition of a deck. The card verification station may include an alphanumeric display that shows a) that the deck has been verified, b) the identity of cards missing, c) the identity of extra cards present, or d) the fact that the deck is no longer complete. In the event that the display shows occurrence b, c, or d, the processor may send a signal to a dealer display, a host computer, a pit computer, or the like, in order to alert the dealer that the deck is no longer ready for play.

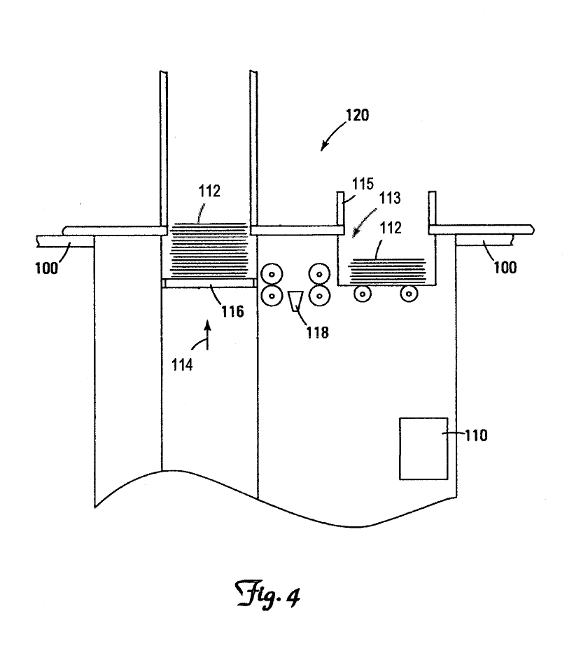

A side cutaway view of a second embodiment of the present invention is shown in FIG. 4. Using a card verification station 120 on the gaming table can be best accomplished by flush-mounting the card verification station 120 into a table surface 100, so that cards 112 are delivered from an elevator 116 in the direction shown by arrow 114 to the table surface 100 at the conclusion of the verification process. A well 113 may be located slightly below the table surface 100. If the number of cards 112 that are inserted into the well 113 as a group exceeds a height of the well 113, it would be desirable to provide a support frame 115 extending upwardly from the gaming table surface 100 to provide additional support to the cards 112 so that the cards 112 remain in alignment. The upright support frame 115 may be removable, and preferably has an opening on one side to facilitate the position of cards 112 in the well 113.

In one embodiment of the present invention, the card verification station 120 is a self-contained device with the intelligence necessary to operate the card-moving mechanisms, an imaging device 118, and the elevator 116. In another example of the invention, the imaging device 118 is in communication with an external computer rather than with an internal processor 110.

Card Verification Station on a Gaming Table with Decentralized Control

In another embodiment of the invention, the card verification station 120 is a data-collection device that is in communication with a microprocessor with associated memory microprocessor, the primary function of which is to date stamp and organize the data and forward the data in real time (or delayed time) to a database residing on an external computer. The database can reside on a computer associated with the gaming table, the gaming pit, or the house computer. The data can be transmitted directly to the database from the microprocessor, or can be sent over a computer network (wired or wireless) from the microprocessor. Once the data is in the database, it can be analyzed with or without other data collected from the gaming table, such as the number of hands dealt or rounds played in a unit of time, the identity of the particular players at the table, the wagers placed, the payouts made, the composition of the hands, the numbers of decks shuffled, the identity of the dealer, the identity of other pit personnel and any other data the casino operator wishes to collect and analyze.

Another example of data that a casino might want to collect is data on the number of rounds of play on a given table over a period of time. A “round,” for purposes of this disclosure, is a completed game sequence in which one or more players participate, wagers are resolved and the playing cards are surrendered at the conclusion of play and returned to the deck, the group of decks, a discard rack or the infeed tray of an automatic card shuffler. A round of play is not an accurate indication of the number of hands played in a given amount of time, as the gaming tables are not always full. The data being collected from the card verification station 120 can be collected in the same way as the data is collected from a round-counting data collection module, except that a signal or event unique to a completed round must be used to increment the round counter (i.e., such as the “end-card feed” signal).

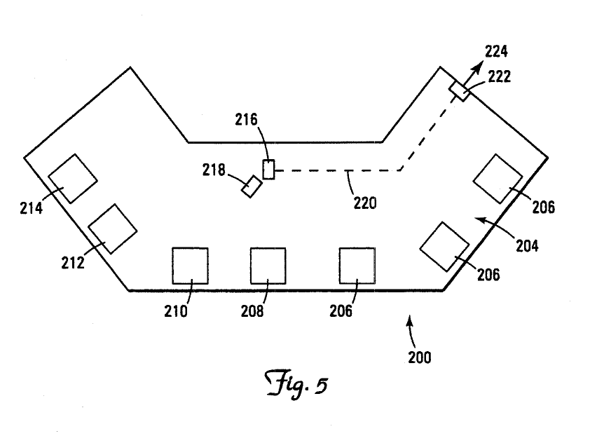

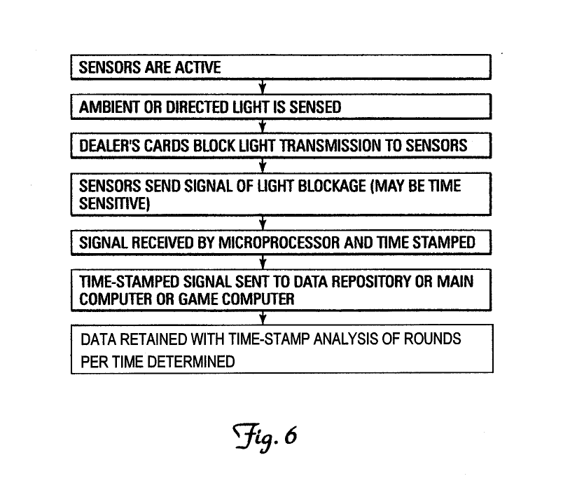

FIG. 5 shows a casino card gaming table 200 equipped with a data collection module capable of tracking the number of rounds of play on the table per a given unit of time. The table 200 has a surface 204 with seven player positions 206 (three positions labeled 206), 208 210, 212 and 214 thereon. A dealer card sensor 216 is provided for the dealer cards 218. The sensor 216 is connected by a communication system 220 (preferably a wired system, but RF or other wireless systems could be used) to a microprocessor 222 for the table 200. The microprocessor 222 is on a communication line 224 (either direct or via a network) to a data collector (not shown). The microprocessor 222 date stamps the data and optionally organizes the data prior to transmission to the database or data collector (not shown). Typically, the microprocessor 222 comprises a field programmable controller with memory. FIG. 6 shows a schematic diagram of data transmission in the system of FIG. 5.

A concept of operative control among processing units should be appreciated to appreciate the decentralized control system used in connection with the card verification station or other data acquisition device. It is believed that existing central control systems perform by means of a single main processor sending commands to peripherals to perform specific functions, and that date stamping is usually done at point of receipt of the data by a gaming processor, especially the main processor. For purposes of discussion, the initial main emphasis of the description will be directed towards the performance of casino table card games with a live dealer, but the system is equally applicable to the use of a fully automated (live dealer-less) gaming apparatus. This emphasis is not intended to narrow the scope of the invention, but is rather intended to simplify the description.

In a standard casino table card game, different events are sensed (usually visually by a live dealer and/or combinations of video cameras and personnel who review images from the video cameras) and the system provides information from these observations. Where there is automated review of information (provided by manual or automatic input), a central processor evaluates this information and commands another element to perform a procedure or initiates a sequential event, including an analytic review of data or providing an alarm or message/report relating to analysis of the data or in response to identification of meaningful data. For example, in known blackjack monitoring systems, when a wager is made and is viewed by cameras or detectors, the bet is recorded and a signal is sent to the main processor that the bet has been made. There are a couple of concepts that are of interest to consider in this performance. First, a fairly sophisticated and powerful processor is needed to control all of the modules, such as a PC-grade processor. Second, the processor must order events to send out separate signals to each of the peripherals, slowing down game performance. Any slowdown in receipt of data may affect the value and treatment of data, including round-counting and deck-verification functions.

There are many different elements of the gaming system that can be considered as peripherals. Another listing of these components would include currency handling, coin acceptors, bill acceptors, paperless transactions, ticket-in and ticket-out crediting, security systems, player accounting functions, door locks, player input (e.g., button controls, joy sticks, touch screens, service calls, etc.), dealer identity, pit supervisor identity, wager measurement modules, card composition modules and any other functions that may be provided on the gaming table.

The units or subcomponents on the gaming table or within the table gaming system can be operated substantially independently of each other, although some interdependencies may exist. In most known systems, substantially all performance of the peripheries is done only at the command of the gaming control processor or central computer.

Some game devices or modules, such as motors, player identification acceptors, etc., require a real-time (RT) operating system (OS) to handle events in a timely fashion. An RTOS operation often adversely affects more traditional OS needs, such as multimedia requirements. Ideally, separating the RTOS from the multimedia frees the multimedia system resources. Additionally, separating the multimedia control from the RTOS will eliminate the version dependencies created by coupling unique RTOS to the multimedia OS.

As noted earlier, round-counting is one service or data acquisition component that can be important to a table. For example, round completion can be important for evaluating rates of play at tables, player rate performance, dealer rate performance, to signal the smart discard rack to start feeding cards, and even disputes over time of completion of hands at different tables or different casinos where priority might be an issue (as in competitive events or qualifying events). Round-counting requires some form of signal generation at a table that is indicative of approximate completion of a round and, preferably, absolute completion of a round. This can be done in a number of ways for signal generation. For example, video cameras can be placed above the table to observe the dealer's hand. When the motions of a dealer or the dealer's cards indicate that the dealer's cards have been removed from the playing area, a signal is sent, such as “round completed,” or “dealer's hand removed,” or some functional equivalent.

Alternatively, a sensor can be placed on the table, over which the dealer's cards are placed. Upright extensions on the card table can interfere with card or chip movement, can cause accidental disclosure of cards, and are generally undesirable. A sensing system with a relatively flat or slightly indented or slightly raised surface is more desirable. The system could comprise a transparent or translucent panel approximately flush with the table surface that allows light (e.g., ambient light or specially directed wavelengths of light to which a sensor is particularly sensitive) to pass to a sensor. The absence of light in the sensor for a predetermined period of time and/or intervals of time can be the original signals themselves, which are interpreted by an intermediary intelligence on the table that has the time-sensing capability for evaluating the signal. The original signals are then time stamped by the microprocessor before being forwarded to the database, where the data can be accessed by analysis programs residing on a computer (e.g., game table computer, pit computer, or main or central computer). The signals themselves are time stamped and the receiving intelligence interprets the signals (light sensed/light not sensed and the accompanying time stamping) to determine if a round should be counted.

For example, before the dealer's hand is dealt, the signal being sent by the sensor is that light is being received. When the dealer's hand has been dealt or during the process of dealing the dealer's hand one card at a time, the dealer places the dealer's cards over the sensor. A signal or state is then sent that light is not being received. If the lack of light signal is of too short a duration (e.g., 1 to 2 seconds), the receiving intelligence, based on the time stamp for a light-admission signal changing to a light-blocking signal and back again, will be programmed to interpret this as a non-round event, such as a dealer leaning on the table or a player throwing away cards, or some article being misplaced over the light-sensing system. Similarly, if the light-blocking event is too long (e.g., 10 to 15 minutes), the intelligence will be programmed to interpret this as a non-round event, such as an inactive table with cards spread over the table and the sensor. The processor receiving the time-stamped signal will be programmed to interpret the data on this basis. The processor can poll the signal-stamping component on a regular basis or wait for a signal or state change information to be received before it acts. By having the date stamping on the original signals at the table before being sent to any computer that analyzes or tabulates or permanently stores the information, a good level of quality information is maintained.

Particularly in games where batch shuffling is used, such as poker or even single-deck blackjack, the signal could also be originated by cards being placed in a shuffler and a shuffling process initiated, the shuffler sending a start-shuffling signal to the date-stamping component on the table. The dealer could even activate or press a button provided on the table, but this would tend to leave the results under the control of the dealer, which could be manipulated by the dealer to improve results on dealer play, or could suffer from forgetfulness.

The application of this technology to gaming tables follows similar architecture and application of design and performance. Gaming tables would include typical casino tables such as those used for blackjack (twenty-one), baccarat, roulette, poker, poker variants (LET IT RIDE® poker, THREE CARD POKER®, Caribbean stud poker, etc.), craps, and the like. These latter systems, unless they are completely electronic without any physical implementation (such as physical playing cards, dice, spinning wheel, drop ball, etc.) will need sensing and/or reading equipment (e.g., card reading for suits and/or rank, bet-reading sensors, ball-position sensors, dice-reading sensors, player card readers, dealer input sensors, player input systems, and the like). These would be the peripherals or data collection modules in the live table systems. Also, newer capabilities are enabled, such as moisture detection (e.g., for spilled drinks), smoke detection, infrared ink detection (to avoid card marking), shuffler operation, dealer shoe operation, discard rack operation, deck verification operation, jackpot meters, side bet detectors, and the like.

The signals and information, when date stamped, do not have to be sent directly, indirectly or even eventually to a main game computer. The term “time stamping” is meant any relatable time entry, such as just time, all the way to time and date. For purposes of this disclosure, the terms “date stamping” and “time stamping” are equivalent. The “time” does not even have to be an actual local or standard time of day, but can be a time from when machines are turned on or when shifts begin, or when dealing starts at a table, etc. As the date stamping of some information, such as the counting of rounds, number of shuffles per hour, number of rounds per shuffle, and the like, do not have any direct and underlying effect on the play of individual rounds of the game, the information may be sent to a data bank or information repository directly from each table (e.g., on a network directly from tables, through a table computer, or central networked computer, etc.). The information need not even be directly sent to a specific repository, but can be placed on a network as information status (as well as a specific signal or data package), such that, when it is received by the data bank or storage repository, the recipient memory device will appropriately log in and/or store the data or signal that is received from each table. This information can be analyzed and stored in real time or stored for later analysis upon command or upon regular intervals.

### The Use of a Card Verification Station on a Table Managed by Distributed Architecture

Alternatives to centralized control of table game operations are now available. A “G-Mod” is a controller associated with a game data acquisition module that date stamps data being acquired from the data acquisition module, and also supports specific functions on the gaming table or associated peripherals (e.g., shuffler). To understand a G-Mod and its function, it is desirable to understand the concept of operative control among processing units. A G-Mod is an electronic hardware element that performs its task independent of direct control from a main processor. The device may have sufficient intelligence to read data and make a decision on data, but its primary task is not to receive and obey commands, but rather to interpret data to determine if a state change has occurred, and then broadcast that change of state to the other system G-Mods. For example, the card verification station G-Mod may receive status signals or status data from the round counter G-Mod and determine whether it is to respond to the signal or data, but is not commanded by the data. Equally importantly, it is capable of sending out status data and/or signal data.

For example, a blackjack gaming table could be equipped with a round-counting sensor and associated G-Mod, a special dealing shoe with a card-count sensor and associated G-Mod, and a card verification station and associated G-Mod. The information collected from these modules can be used to determine the number of rounds played, the number of players per round, the number of hands played and whether any cards were inserted/removed from the deck during a particular play session. While this information is being date stamped and fed into the central database, the G-Mods are controlling the collection of the data by broadcasting signals to the other G-Mods via a communication network, eliminating the need for central control. The advantages of decentralized control are numerous. Generally, multiple microprocessors are less expensive than a central control unit. Adding modules does not normally require a rewriting of all or part of the central software. No software needed to operate each G-Mod must be rewritten when modules are added or removed.

A card swipe module could be added to the table system, with an associated G-Mod. This G-Mod could not only transmit time-stamped data to the data repository, but could also transmit player I.D. information to the player-tracking system residing in the casino computer system, or dealer I.D. information to link a specific dealer to a specific table and to evaluate the specific dealer.

One or more sensors could sense information transmitted through an output data port of a shuffler, for example, or a keypad control used to issue commands to a shuffler. The shuffler would have its own G-Mod and would be capable of transmitting date-stamped information, such as number of cards per hand, number of hands per hour, number of cards dispensed per unit of time, number of player positions occupied, number of cards re-fed into a continuous shuffler per unit of time, number of promotional cards dispensed per unit of time, bonus awards granted at a certain time, and the like. This information could be collected in a central database, data bank or information repository (e.g., any electronic memory or storage system).

A bet interface module could also be provided. Known techniques for measuring wagers include optical- and metal detection-type bet-present sensors for fixed bets, and camera imaging, radio frequency/identification technology, and the like, for measuring the amount of the bet, as well as the presence of the bet. Outputs from these measurement devices are fed through a dedicated G-Mod and the data is date stamped and delivered to the central data depository.

Another possible G-Mod could control a card-reading camera located in either the card shuffler, the dealing shoe, the discard tray or combinations of the above. Information about the specific cards dealt to each player could be obtained by feeding date-stamped information about cards dealt and returned. In one form of the invention, the G-Mod sends date-stamped information to the database and an algorithm residing in the same computer or house computer uses this information, as well as round-counting and betting information, to determine the composition of a hand of blackjack, for example.

Another G-Mod might be in communication with an identification system for tracking the movement of employees in and out of the pit, or more preferably, when the dealers arrive at and leave the table. This information could be collected and reported along with rounds of play per hour to determine which dealers deal the most hands in a given period of time.

In a roulette application, a sensor and associated G-Mod can record the number of spins of the wheel in a unit of time, for example. This information could be associated with the player swipe card information from another G-Mod by merely comparing the time stamping of the data to determine how long a particular player stayed at a table. A sensor or G-Mod may “listen in” to communication to the reader board on a roulette table, and send that information to a data bank, so that a distinct sensor is not needed to read the position of the ball separate from existing components.

It is important to note that none of the G-Mods are in communication (e.g., direct communication or command, although data or signal transmission from one G-Mod may pass through the communication network of one or more other G-Mods, without the signal being a command to any other G-Mod) with other G-Mods on the same gaming table. Also, the data repository does not issue commands to the G-Mods, except to initialize the G-Mods on power-up. The central database merely organizes the data in a manner that allows for easy access by external or other associated computers or another application program residing on the same computer as the database. In this respect, the G-Mods are self-executing and do not require central intelligence to perform their individual functions. The data may be analyzed and used to make decisions about comping players, promoting pit personnel, closing and opening tables, determining optimal betting limits for given periods of time and other important managerial functions.

Each G-Mod may be in data communication with an interface device, such as one or more specialized circuit boards, to allow the data from multiple G-Mods to be fed into a standard port of the computer that serves as the data repository.

A software interface can be provided to directly access data in the data repository and to manipulate and organize the data so that it can be outputted onto a display, written report or data stream so that the data can be interpreted. In one preferred software interface program, the operator can obtain reports of rounds of play per hour per actual table, per pit, or per property, as determined by the user. The information in the form of a data stream may be further analyzed. In one example, the data is fed into a host computer or can be analyzed in the same computer system where the database and interface reside. For example, the data from one or more of the round-counting module, the shoe sensor, the card swipe module, card-reading module, smart discard rack, the shuffler data port sensor, and the bet interfaces can be used to create a report of rounds played per unit of time, the number of players at the table per unit of time, the number of hands played at each round, the maximum bet per player in a given unit of time, the average bet per player in a unit of time, the number of shuffles per unit of time, the number of cards removed from and placed into the shuffler in a unit of time, hand composition and other information considered important to the casino.

Because all of the G-Mods work independently, the casino operator can choose the modules and resulting data that is most important to them, while saving valuable resources by only purchasing the sensing/data analysis packages they need. For example, one casino might want to reconstruct individual hands, track betting and associate the information with a particular player in a high-stakes game, while tracking only rounds and the identification of the employees on low-stakes games.

By using a modular approach to data collection, only the equipment and reports that are wanted can be provided at the lowest possible cost. Since none of the G-Mods are in command communication with one another, it is not necessary to rewrite any code when additional modules are added.

### The Use of a Card Verification Station as a Back Room Deck/Multiple Deck Checking Device

The card verification station of the present invention may be used by a casino to check the integrity of decks or groups of decks of cards prior to commissioning the cards for use on the casino floor or as part of the decommissioning process. The system includes a card verification station as shown in FIGS. 1-3. An external computer (not shown) is in communication with the microprocessor of the card verification station, and the card-imaging device. The external computer has memory. Stored in memory is the rank and suit information of the set of cards being verified. A group of cards is inserted into the station, and the rank and suit of the cards are read. Cards exiting the device remain in the same order as the cards as they are fed. The external computer compares the read data to the stored data and generates a report of at least one of: a) the total number of cards read, b) extra cards present, c) cards missing, d) number of extra cards, e) number of cards missing, d) a verification that the group of cards is complete. A printer may be provided to generate a report that the group of cards is ready for use on the casino floor, or that there are deviations from the cards that should be present in the group. The external computer may also be equipped with a monitor or other device capable of displaying information relating to the composition of the scanned cards, and deviations from the stored values.

The present invention may include a method of verifying cards either prior to, during or after use on a gaming table. The method includes the steps of: providing a deck verification device capable of reading cards individually to determine rank and suit; feeding in a group of cards selected from the group consisting of: a deck of cards, plural decks of cards, special decks of cards and plural special decks of cards; reading rank and suit of each card; forming a stack of read cards, wherein the cards are in the same order as they were prior to being read; comparing the rank and suit of the read cards to stored values for a complete deck or decks of cards; and providing a visual indication of deviations between the rank and/or suit of read cards and stored values. The deck or decks are preferably unmarked standard cards, and the device or devices used to read the rank and suit can be cameras or other optical imaging devices. Machine vision software can be used to interpret the images. In one application of the method, the deck verification device is placed near or on the gaming table so that the method can be practiced either before, during or after play, or at the request of management. In one preferred form of the method, the deck verification device is flush-mounted into the gaming table surface. Preferably, the entire group of cards used in the play of the game is verified to determine if the set is complete. In another example of the invention, sets of cards are verified prior to commissioning the cards to be used on the casino floor. When the deck verification device is flush-mounted into the table surface, it is desirable to elevate the verified group of cards to the playing surface after reading. In a third form of the invention, decks or groups of decks are verified after use and prior to the card being decommissioned. Decommissioned cards are either destroyed or modified and sold as souvenirs.

When verifying complete sets of cards, the method can include comparing the read values to stored values. The stored values are typically located on an external computer.

A casino may use the device of the present invention in a number of distinct manners. In addition to using a card verification station to read the rank and/or suit of the cards as the cards leave the table, the card verification station could be used to check the completeness of the deck at the table, either before or after a round, a shift or a period of play. Another aspect of the present invention is to use the deck verification station as a component of a back-end casino system for checking decks prior to play and/or prior to retiring or decommissioning cards. For example, a casino might receive cards in either pack order or in a random order from the manufacturer. It is fairly easy to spread out a deck of ordered cards and confirm visually that all the cards are present, but when the cards are randomized prior to packaging, (manual) visual indication is no longer possible. It would be desirable to read the cards to check that the decks or packs of decks are complete, prior to using the cards in a live casino game.

For instance, in the game of standard blackjack, the casino typically combines eight decks of 52 cards each, with jokers removed. The casino could use the card verification station of the present invention to confirm that each of the 416 cards is present and that no additional cards are present. The casino might also use the card verification station to verify that packs of cards removed from play are complete, as a security measure, prior to decommissioning the cards. The casino could run the packs through the card verification station to check the packs for this purpose also.

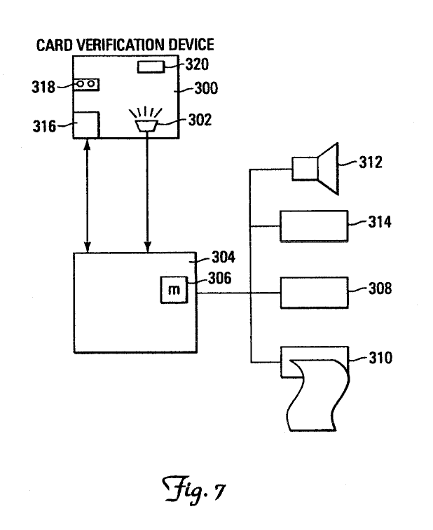

Referring now to FIG. 7, when a card verification station 300 is used as a back-end deck or pack checker, it is preferable that an imaging system 302 located in the card verification station 300 be in information communication with an external computer 304. Residing within the external computer 304 is memory 306 holding card information regarding the standard composition of the deck or packs of decks of cards. A comparison program (not shown) also resides in memory 306 and is provided so that, after the imaging system 302 scans each card to be verified, the program compares the scanned values to actual values and creates a report. The data may be shown on an external display such as a monitor 308 with or without touch screen controls, may be printed in a printer 310, may be transmitted as an audible signal from a speaker 312, or combinations thereof.

Information that is typically inputted into the external computer 304 via a keyboard 314, touch pad controls, joystick, voice command or other known data input means prior to checking the decks might include a) the identity of the card verification station equipment, b) the identity of the dealer who either is about to receive or has just removed cards from the table, c) the pit number, d) a table i.d., e) the number of packs to be sorted, f) the identity of the game, g) the number of decks in the pack, h) the date, i) the shift, and j) any other information useful in creating an identity for the pack of cards being sorted.

The external computer 304 outputs information such as the number of cards missing, the number of extra cards, the identity of cards missing, the identity of extra cards, the fact that the pack of cards is complete, the table i.d., the dealer i.d., the pit i.d., the game, the employee i.d., the date, time, shift and any other data that has been inputted and is requested by the casino.

The card verification station 300 has its own internal processor 316 that controls the operation of the card verification station 300. The processor 316 will issue commands to motors, elevators and the like, to accomplish card movement at the request of a dealer input device 318 or an instruction from the external computer 304. In one embodiment (not shown) only the imaging system 302 is in communication with the external computer 304. In another example of the invention, both the internal processor 316 and the imaging system 302 are in communication with the external computer 304. The internal processor 316 might notify the external computer 304 when a batch has started to process or when a batch is complete, for example. If the card verification station 300 has an integral external display 320 (such as an LED, LCD, multi-segment or graphic display, for example), the display 320 could receive information from the external computer 304 on what information to display. Any information that is included on display 308 could also be shown on the display 320 affixed to the card verification station 300.

The card verification station of the present invention may be used to read and verify cards at various stages of card use, as the verification of cards is often desirable, before, during and after play of casino card games.

The method of the present invention can also include sending the read signals to at least one of a microprocessor and a G-Mod to date stamp the data prior to storing the data in an external database. The data in the database can be accessed in real time or at a later date to verify the group of cards used in the game was intact and validated as complete.

The above examples are clearly exemplary and are not intended to be limiting in the practice, disclosure or enablement of the invention. As noted, any image capture device may be used that can read information relating to symbols and can access symbol-reading software, any sensor can be used as a position sensor if it can sense the presence and/or absence of a playing card, drives in the device can be belt drives, gear drives, hydraulic drives, step motor drives or the like, and other variations in software selection, hardware selection, communication modalities, and the like, are within the skill and selection options of the designer or practitioner.

All of the apparatus, devices and methods disclosed and claimed herein can be made and executed without undue experimentation in light of the present disclosure. While the apparatus, devices and methods of this invention have been described in terms of both generic descriptions and preferred embodiments, it will be apparent to those skilled in the art that variations may be applied to the apparatus, devices and methods described herein without departing from the concept and scope of the invention. More specifically, it will be apparent that certain elements, components, steps, and sequences that are functionally related to the preferred embodiments may be substituted for the elements, components, steps, and sequences described and/or claimed herein while the same or similar results would be achieved. All such similar substitutions and modifications apparent to those skilled in the art are deemed to be within the scope and concept of the invention as defined by the appended claims.

What is claimed is:

1. A method of verifying cards, comprising:
accepting cards removed from play of a casino card game;
automatically moving cards individually past an image capture device and scanning to determine at least one of rank and suit of each card using the image capture device;
comparing at least one of the determined rank and suit information of each card to at least one of rank and suit information for a card set comprising the removed cards stored in memory; and
decommissioning each scanned card.

2. The method of claim 1, wherein cards from multiple players participating in a round of play of the casino card game are decommissioned.

3. The method of claim 1, wherein the comparison of the at least one of the determined rank and suit information of each card to the at least one of rank and suit information for a card set comprising the removed cards stored in memory is performed by a processor.

4. The method of claim 1, further comprising using a CCD camera sensor as the image capture device.

5. The method of claim 1, wherein the decommissioning is effected by destroying all or part of each scanned card.

6. The method of claim 1, wherein the removed cards are accepted into an infeed tray.

7. The method of claim 1, wherein the removed cards comprise exhausted hands.

8. The method of claim 1, wherein the removed cards comprise swept hands.

9. The method of claim 1, further comprising generating a signal indicating a fault event when the at least one of the determined rank and suit card information does not correlate with the at least one of the stored rank and suit information for a card set comprising the removed cards.

10. The method of claim 1, wherein the decommissioned cards comprise the complete set of cards.

11. The method of claim 1, wherein a portion of the cards removed from play includes unused cards.

12. The method of claim 1, and further comprising date stamping data generated by the image capture device.

13. The method of claim 1, wherein the decommissioning is effected by modifying each scanned card.

14. The method of claim 1, further comprising storing the at least one of rank and suit card set information in memory of an external computer.
